(19) United States
(12) Patent Application Publication
(10) Pub. No.: US 2013/0011531 A1
(43) Pub. Date: Jan. 10, 2013

(54) Frozen confection modular mold

(76) Inventor: Andrea Rae Wolf, West Harrison, IN (US)

(21) Appl. No.: 13/135,477

(22) Filed: Jul. 7, 2011

(51) Int. Cl. A23G 9/26; B29C 39/10; A23P 1/10; A23G 9/08

(52) U.S. Cl. 426/241; 249/97

(57) ABSTRACT

Modular mold unit and space-saving modular mold assembly, method, and article of manufacture for forming and preparing frozen confections that allow a quick release of the frozen confections from the mold by a microwave oven, wherein the mold unit is made of plasticizer-free, unadulterated, nonrecycled, heat-stable, microwave-transmissible plastic. The modular mold unit comprises a container member and a detachable lid member, wherein said container member has a top side, a body side comprising a vertical rectangular or square flange section with four vertical sides, and wherein said detachable lid member has a stick member that is integrally molded with said lid member. Alternatively, said removable lid member is a stick-supporting lid having a central collar with a longitudinal slot opening to frictionally hold a separate wooden or plastic stick. The mold assembly comprises a plurality of modular mold units that are held to one another at the level of the vertical flange sections by a reclosable and releasable strap.

### BACKGROUND OF THE INVENTION

1. Field of the Invention

This invention relates to a modular mold unit and space-saving modular mold assembly for forming and preparing a frozen confection, especially frozen confection on a stick, such as flavored ice and ice cream, that allow a quick release of the frozen confection from the mold by microwave radiation, said mold unit and mold assembly being made of plasticizer-free, unadulterated, nonrecycled, heat-stable, microwave-transmissible plastic. This invention also relates to a method using said mold unit and mold assembly to produce said frozen confection including the step of using microwave radiation for heating to quickly and conveniently release said confections from said mold.

2. Description of the Related Art

The first popsicle is disclosed in U.S. Pat. No. 1,505,592 issued Aug. 19, 1924 to F. W. Epperson, which discloses a method for making frozen confections on a stick using test tubes to contain liquid syrup and a wooden stick. When the freezing operation is completed the container is immersed in luke warm water to loosen the frozen confection from the container to remove the confection from the container. A negative of such mold is such glass test tubes can be accidentally and easily broken or shattered.

Subsequently, there are other disclosures of mold assemblies for preparing frozen confections at home. U.S. Pat. No. 2,946,207 issued Jul. 26, 1960 discloses a mold assembly consisting of a plurality of individual cups integrally joined together with a web or sheet. Each cup has a lid or cap with a stick-like arm depending therefrom that is immersed in the liquid contained in the cup to support the resulting frozen article when the liquid is frozen in a freezer. Each cap also has a handle situated on the opposite side of the stick-like arm. The integral cups and web are made of resilient plastic material such as polyethylene, polypropylene, polystyrene, and polyvinyl chloride. No instructions are provided for how the frozen confections are to be released from the cups. The risk of the presence of plasticizer in the resilient plastic material is not appreciated.

U.S. Pat. No. 4,239,175 issued Dec. 16, 1980 discloses an improvement over U.S. Pat. No. 2,946,207, wherein each cap that serves to retain any molten liquid is provided with a straw member to allow the molten liquid therein to be drawn off. The mold assembly is formed from a synthetic plastic material. No instructions are provided for how the frozen confections are to be released from the cups except a disclosure that the cap member can be lifted upwardly to remove the frozen product from the cup member. The risk of the presence of plasticizer in the resilient plastic material is not appreciated.

U.S. Pat. No. 5,354,191 issued Oct. 11, 1994 discloses a variation from U.S. Pat. No. 4,239,175, with the mold assembly comprising a planar tray member wherein the cups can either be integral parts of the tray member or be removably mounted in the openings of the tray member, and wherein the caps (or covers) of the cups also include passageway arrangement to draw off any melted liquid. The mold assembly can be made from any suitable synthetic plastic materials. For consumption, the cover and holder assemblies can each be removed with the frozen food product from its associated container by any of a plurality of heating techniques, such as applying hot water to the outer surface of the container.

In the hereinabove U.S. Pat. Nos. 2,946,207, 4,239,175, and 5,354,191, there is no anticipation of heating by microwave radiation nor indication of concern of a potential of leaching or migrating of toxic plasticizers from the plastic to the comestible confection, especially upon heating, especially heating under microwave radiation, nor a potential of degradation of plastic that can result upon heating, especially heating under microwave radiation, to form toxic by-product ingredients that would contaminate the comestible confection.

U.S. Pat. No. 3,411,463 issued Nov. 19, 1968 discloses a mold assembly comprising a rigid plastic tray having openings to hold a series of metallic cups, each cup is covered by a flexible stick-supporting cap having a slot that is centrally located to frictionally hold a wooden stick. The flexibility of the plastic cap allows it to be snapped to the rim of the cup. The cups are filled with confection liquid then inserted in the openings of the tray, and the whole assembly is placed in the freezer compartment of a home refrigerator to be frozen. It is disclosed that the frozen comestible can be separated from its cup by subjecting the latter for a short period of time to the heat of a human hand. The metallic cups do not contain plasticizer but they are not microwave-transmissible to allow heating by microwave.

U.S. Pat. No. 6,301,919 issued Oct. 16, 2001 discloses a machine that can be used by children to make ice cream bars on a stick wherein the machine includes metal containers to receive and hold ice cream bar mix.

Homemade ice cream bars or popsicles are frozen in the freezer compartment of a home refrigerator, and the frozen bars are extracted from the molds by warming the outside of the molds to melt the interface of the frozen bars and molds then pulled from the molds using the inserted sticks. The common method for warming the molds is to place them upside down or sideways under a stream of hot or warm tap water. A commercially available mold assembly that comprises eight cups integrally joined together with a plate that is produced by Arrow Plastic Manufacturing Co., Elk Grove, Ill. 60007, has the following instructions: “Fill to just below top. Insert sticks and place in freezer. To remove, run water on outside of pops.” This heating method is not efficient because the water flow and coverage are not uniform, thus the hot water is not applied uniformly. Furthermore, the walls of the plastic molds are heat-insulating, so that it usually takes some time to thaw the surface of the frozen bars. Also, the water flow is not easily controlled, such that water spilling into the inside of the molds to contaminate the comestible bars can occur.

Integral trays disclosed in the above U.S. Pat. Nos. 2,946,207 and 4,239,175, and the mold assembly that is provided by the Arrow Plastic Manufacturing Co. do not allow the flexibility of making the exact number of frozen confections that are needed, and thus they can undesirably occupy more room in the freezer compartment than needed. For example, using a tray with eight cups to make four frozen confection units leaves four empty cups that take extra room. To make ten frozen confection units required two trays with even more room that is wasted. Even the mold assemblies with individual cups that are disclosed in U.S. Pat. Nos. 3,411,463 and 5,354,191 can unnecessarily take extra room in the freezer compartment, because the tray requires the full space even when less than maximum number of individual cups are used with the tray.

It is therefore an object of the present invention to provide an improved space-saving modular mold unit and mold assembly that allow the preparation of an exact number of frozen confections that are needed without taking extra space in the freezer compartment of a home refrigerator.

It is also an object of the present invention to provide an improved mold for forming and preparing frozen confections that allows heating in a microwave oven for a quick, convenient, and hygienic release of the frozen confections that also avoids the step of releasing the confections by hot running water that is inconvenient and may contaminate the frozen confections.

Other objects and advantages will become apparent and understood by reference to the following detailed description of the preferred embodiments that follows.

### SUMMARY OF THE INVENTION

The present invention relates to modular mold unit and space-saving modular mold assembly for making frozen confections, wherein each said modular mold unit comprises a container member and a removable and reclosable lid member, wherein said container member comprises a vertical rectangular or square flange section at its upper body side to allow a plurality of such mold units to be bundled and tied to one another with a strap to form a mold assembly, and wherein said mold assembly allows the preparation of an exact number of frozen confections on a stick that are needed without causing extra dead space in the freezer compartment of a home refrigerator. The container member of the modular mold unit comprises an opening on the top side, wherein said opening is covered by a removable lid member, wherein said lid member comprises a raised ridge that fits snuggly over said opening, and said lid member further comprises an interior stick-like anchor to support the frozen confection and an exterior handle, wherein said interior stick-like anchor and said exterior handle are integrally molded to said lid. Non-limiting examples of the suitable strap for use in the present invention include Velcro strap, reclosable cable tie, and rubber band.

This invention also relates to modular mold units and mold assembly for forming and preparing frozen confections on a stick, that allow a quick release of the frozen confections by microwave radiation, said mold units being made of plasticizer-free, unadulterated, nonrecycled, heat-stable, microwave-transmissible plastic.

In another embodiment, said removable lid member is a stick-supporting lid having a central collar with a longitudinal slot that is centrally located in said lid to frictionally hold and support a wooden or plastic stick and to divide said stick into a handle and an anchor, and wherein said lid member is optionally made of semi-rigid silicone rubber.

This invention also relates to a method of producing frozen confections, such as flavored ice and ice cream, including the step of placing liquid confection material in the receptacles of the modular mold units of the mold assembly, with said mold units and mold assembly being made of plasticizer-free, nonrecycled, heat-stable, microwave-transmissible plastic; placing the molds in a freezer compartment to freeze the liquid, and using microwave radiation to hygienically, quickly and conveniently release said frozen confections from said molds.

This invention also relates to an article of manufacture that provides frozen confection modular mold units as described above, and that optionally provides other parts such as wooden sticks and connecting strings or straps, and instructions for use; and wherein such modular molds can carry an indicia that, e.g., either identifies the molds, describes their convenient use, etc. It is important to provide instructions that indicate that the molds can safely be used in a microwave oven for quickly, conveniently, and hygienically releasing the confections from the molds, to provide the user with an appropriate incentive for using the invention.

In this document, the term “about” is presumed to modify all numerical values, it being understood that exact numerical values are not required unless it is specifically stated.

### BRIEF DESCRIPTION OF THE DRAWINGS

FIG. 1 is an exploded perspective view of an embodiment of a modular mold unit of the present invention, comprising an tapered rectangular cylindrical container member having a vertical rectangular flange section and a removable lid member with a stick-like arm and a handle situated on the opposite side of the stick-like arm, wherein the stick-like arm and the hand are integrally molded to the lid member;

FIG. 2 is a cross-sectional view of the modular mold unit of FIG. 1 showing the broad view of the container member with the removable lid member fitted to the container, taken along line 2-2 of FIG. 1;

FIG. 3 is a cross-sectional view of the modular mold unit of FIG. 1 showing the narrow side view of the container member with the removable lid member fitted to the container, taken along the line 3-3 of FIG. 1;

FIG. 4 is a perspective view of an assembly of a plurality of the container members of the modular mold unit of FIG. 1 showing eight containers which are closely stacked and bundled together, and firmly held together by a Velcro®-type strap at the level of the vertical rectangular flange sections;

FIG. 5 is the overhead view of an assembly of eight modular mold units of FIG. 1 showing eight mold units which are closely stacked and bundled together, and firmly held together by a Velcro®-type strap;

FIG. 6 is an overhead view of another assembly of a plurality of modular mold units of FIG. 1 showing five mold units which are bundled and firmly held together by a releasable cable-tie-type strap;

FIG. 7 is an exploded perspective view of another embodiment of a modular mold unit of the present invention, comprising a tapered circular cylindrical container member and a removable lid member, wherein the container member has a vertical square flange section with vertical sides and wherein the removable lid member has a central collar with a slot which holds a separate elongated flat stick;

FIG. 8 is a cross-sectional view of the removable lid member of FIG. 6 showing the broad view of said lid member taken along line 8-8 of FIG. 7, wherein said lid member comprises a central collar with a longitudinal slot opening holding a stick;

FIG. 9 is an overhead view of the container member of the modular mold unit of FIG. 7 showing the square top side comprising the outer edges and the circular rim of the container section. The cavity reveals the inner side of the circular bottom side, and the inner side of the outer tapered circular cylindrical side;

FIG. 10 is a cross-sectional view of the container member of FIG. 9 showing the side view of said container member taken along line 10-10 of FIG. 9; and

FIG. 11 is a cross-sectional view of the container member of FIG. 9 showing the diagonally oblique side view of said container member taken along line 11-11 of FIG. 9.

These drawings are not drawn to scale and are intended for illustrative purposes only.

### DETAILED DESCRIPTION OF THE INVENTION

The present invention relates to a modular mold unit and a space-saving modular mold assembly for forming and preparing frozen confections, said mold unit and mold assembly allow the preparation of an exact number of frozen confections on a stick that are needed without taking any extra space in the freezer compartment of the home refrigerator. Preferably said mold and mold assembly allow a quick release of the frozen confections from the mold by microwave radiation, preferably a home microwave oven, wherein said mold is made of microwave-safe plastic comprising plasticizer-free, unadulterated, nonrecycled, heat-stable, microwave-transmissible plastic.

“Modular mold unit,” as used herein, means that each individual mold unit comprises a container member or cup having a vertical rectangular or square rim or flange at its top side to allow a plurality of such mold units to be assembled (or stacked and bundled to one another) and tied together with a strap to form a mold assembly, wherein each said modular mold has an opening on the top side covered by a removable lid member or cap, and wherein said modular mold is not part of a mold assembly that is either (a) integrally joined together with a tray (or a web or sheet) that has fixed and predetermined dimensions, such as those that are disclosed in U.S. Pat. Nos. 2,946,207 issued Jul. 26, 1960 to Hulterstrum, 4,239,175 issued Dec. 16, 1980 to Straubinger, and 5,354,191 issued Oct. 11, 1994 to Bobis, all said patent are incorporated herein by reference, or (b) a part of a mold assembly wherein said mold assembly comprises a flat rigid plastic tray (or top) with spaced feet for supporting said tray and having fixed and predetermined dimensions and having openings to hold a plurality of said mold, such as those that are disclosed in U.S. Pat. Nos. 3,411,463 issued Nov. 19, 1968 to Moseres, and 5,354,191 issued Oct. 11, 1994 to Bobis, all said patent are incorporated herein by reference. “Microwave-safe plastic,” as used herein, means plasticizer-free, unadulterated, nonrecycled, heat-stable, microwave-transmissible plastic. “Plasticizer free,” as used herein, means that the plastic material used in the present invention does not contain plasticizers, which are additives to plastics to make them more flexible. Plasticizers can be harmful to the health, even carcinogenic, when consumed, even at low levels. Plasticizers are not bound to plastics and can migrate out of plastic, especially by heating, more especially by heating by microwave which is essential for the method of heating of the present invention, and contaminate the confection to be consumed. “Unadulterated,” as used herein, means that the plastic material used in the present invention is not blended with other types of plastics or recycled plastics. “Nonrecycled,” as used herein, means that the plastic used in the present invention does not contain any recycled plastic, which is plastic material that had been used before and is recycled and blended with new plastic. Recycled plastic is mixtures of prior used plastics that are collected from many sources, some of which can contain plasticizers. “Heat-stable,” as used herein, means that the plastic used in the present invention is not degraded by heat. Polymers such as polystyrene and polycarbonate are generally not heat stable and also contain bisphenol A. Polyvinyl chloride plastic normally contains phthalate plasticizer and bisphenol A. “Microwave transmissible,” as used herein, means that the material allows a substantial amount of microwave radiation to pass through. Plastic materials normally are microwave-transmissible except when they are embedded with metallic materials. Metallic molds are generally not microwave-transmissible. Preferred plastic material for use in the present invention include plasticizer-free, unadulterated, and nonrecycled polyethylene terephthalate (polyester), plasticizer-free, unadulterated, and nonrecycled polypropylene, plasticizer-free, unadulterated, and nonrecycled high density polyethylene, plasticizer-free, unadulterated, and nonrecycled low density polyethylene, and semi-rigid silicone rubber. Due to its flexible nature even without containing plasticizer, the semi-rigid silicone rubber is a preferred material to make the lid of the individual mold. For the purpose of this invention, molds made with glass, rubber, latex, or metal are not preferred. Polyvinyl chloride, polystyrene, and polycarbonate should be avoided.

The consumer has endured for many years the problems of inconvenient removal of frozen confections by the use of running water and of the space requirement to store half empty mold assembly in the freezer. It is surprising that heating by microwave radiation still can preserve the integrity of the frozen confection bars, and this novel heating method for releasing frozen confection bars has provided more convenience and safety in the preparation of frozen confections for home consumption.

Thus this present invention relates to a modular mold unit for making frozen confection comprising a container member (or cup) and a removable (or detachable) lid member (or cap), wherein said container member comprises a top side having an opening to a receptacle to receive and hold a flavored liquid syrup to be frozen, and a body side that comprises a vertical rectangular or square flange (or tube) section with four vertical sides; wherein said lid member comprises a raised ridge that fits snuggly over said opening to the receptacle, an interior stick-like arm (or anchor) depending from said lid member to support the frozen confection, and an exterior handle-like arm situated on the opposite side of the stick-like arm from the lid member, said anchor and said arm are integrally molded with said lid member, and wherein said container member and said lid member are made of plasticizer-free, unadulterated, nonrecycled, heat-stable, microwave-transmissible plastic.

The removable lid member can alternatively be a stick-supporting lid, wherein the lid body comprises a central collar having a longitudinal slot that frictionally holds a separate elongated flat wooden or plastic stick, preferably a stick with round ends, and divides said stick into an exterior portion serving as the handle and an interior portion serving as the anchor to hold the frozen confection. The lid member is made of microwave safe plastic, preferably semi-rigid silicone rubber that allows it to fit closely to the rim of the opening of the container member. The preferred lid that is made of semi-rigid silicone rubber can also better enable the vertical slot opening of the central collar to grip the inserted stick and allows a snuggly fitting of the stick into the slot opening. The plastic stick is made of microwave-safe plastic comprising plasticizer-free, unadulterated, nonrecycled, heat-stable, microwave-transmissible plastic.

In one embodiment of the present invention, the container member comprises a rectangular top side comprising a rectangular opening to the receptacle, said receptacle comprising the vertical rectangular tube section as its upper section, a lower tapered rectangular cylindrical section, and a rectangular bottom side; wherein said vertical tube section comprises two opposing vertical sides with long width and two opposing vertical sides with short width, and wherein said vertical sides superiorly share the same edges with said rectangular top side, and inferiorly share the same edges with said tapered rectangular cylindrical section. Preferably, said rectangular top side has rounded corners, said rectangular tube section has vertical rounded edges, said tapered rectangular cylindrical section has rounded edges, and said rectangular bottom side has rounded corners.

In another embodiment of the present invention, the container member comprises a square top side comprising a round opening to the receptacle, a body side comprising a square flange (or tube) section with four equal vertical sides, and a receptacle comprising a tapered circular cylindrical section and a round bottom side, wherein said four vertical sides of said square flange superiorly share the same edges with said square top side, and the top circular rim of said inner tapered circular cylindrical section shares the same circular edge of said round opening of said top side. Preferably, said square top side has rounded corners and said rectangular tube section has vertical rounded edges.

The present invention also relates to a mold assembly comprising a plurality of modular mold units that are closely packed and bundled to one another, with the vertical edges of one modular mold unit being placed flatly against the vertical edges of other modular to form a bundle of mold units, said bundle is firmly held to one another by a flexible and reclosable strap.

Non-limiting examples of reclosable straps that can be used to form a mold assembly of the present invention include Velcro®-type strap, a plastic releasable cable tie, and a rubber band, of suitable lengths to firmly hold a desirable number of modular mold units together. These straps can be adjustably reused to hold a varying number of modular mold units. Examples of Velcro®-type strap are those disclosed in U.S. Pat. Nos. 5,518,795 issued May 21, 1996 to Kennedy et al.; 6,044,525 issued Apr. 4, 2000 to Sastre et al.; 6,248,419 issued Jun. 19, 2001 and 6,737,147 issued May 18, 2004, both to Kennedy et al.; and the references cited therein. A non-limiting example of a suitable Velcro strap is the One-Wrap Straps® that are available from Velcro USA Inc., Manchester, N.H. 03108, when the straps are made with suitable length to hold a desirable number of modular mold units together. A preferred Velcro-type strap has suitable length and comprises two sides, wherein the first side is fully covered with loops, while the second side is covered with hooks only at one end and with a tip not covered to facilitate the opening of the strap to release the modular molds. An example of said strap is marketed under the name “Cable Ties” by Belkin Corporation, Compton, Calif., USA, with appropriately extended lengths to hold the mold assembly. Another non-limiting limiting example of a reclosable strap that is useful in the present invention is one or more of the various types of plastic releasable cable ties with suitable widths and lengths. These releasable straps typically comprises an elongate strap and a locking head with an opening that receives the free end of the strap, said head having a mechanism to lock the strap tightly in place, when the strap is wrapped around an object, such as a bundle of electric cables or a pack of modular mold units of the present invention, and pulled tightly through the head to tie the strap around the object. The releasable ties are described in, e.g., U.S. Pat. Nos. 3,908,233 issued Sep. 30, 1975 to Caveney et al.; 3,991,444 issued Nov. 16, 1976 to Bailey; 4,236,280 issued Dec. 2, 1980 to Kreiseder; 5,193,250 issued Mar. 16, 1993 to Caveney; 5,414,904 issued May 16, 1995 to Sampson; 6,185,791 B1, issued Feb. 13, 2001 to Khokhar; and 7,281,302 issued Oct. 16, 2007 to Hewes; and the references cited therein. The mold assembly of the present invention allows the preparation of an exact number of frozen confections that are needed without taking extra space in the freezer compartment of a home refrigerator. Furthermore, this mold assembly allows the removal and heating only the exact number of confection units that are needed. The number of unused frozen confections in the intact modular mold units can be re-stored in the freezer compartment with a reduced volume.

The present invention also relates to an article of manufacture comprising the mold assembly described hereinabove, one or more reclosable and releasable straps, optionally a plurality of wooden or plastic sticks, and optionally instructions for use.

The instructions for use provide information including one or more of: the molds can be used to save space in the freezer compartment; the molds can be safely used in a microwave oven for quickly, conveniently, and hygienically releasing the confections from the molds; and/or the way to determine the length of time needed to heat the mold units in a microwave oven; wherein said instructions for use are printed on one or more of the package; the accompanying instruction flyer; and/or communicated via print and/or electronic mass media: newspapers, magazines, radio, television, interne, circulars, and the like, and wherein said instructions can be in words, or illustrative images and/or icons including in combination with words.

The present invention also relates to a method for production of frozen confections that allows the preparation of an exact number of frozen confections on a stick that are needed without causing extra dead space in the freezer compartment of a home refrigerator, and that allows a quick, hygienic, and convenient release of the frozen confections by a microwave oven, said method including the steps of:
(1) providing a plurality of modular mold units described hereinabove; wherein each said mold unit comprises a removable lid member comprising either an interior stick-like anchor and an exterior handle which are integrally molded to said lid; or a central collar with a longitudinal slot that is centrally located in said lid to frictionally hold and support a separate wooden or plastic stick and to divide said stick into a handle and an anchor;
(2) closely stacking the desired number of modular mold units together with one or more of the vertical sides of one mold unit being placed flatly against one or more of the vertical sides of other mold units to form a mold assembly comprising a bundle of mold units;
(3) firmly holding and tying said bundle together using the releasable and reclosable strap to form an assembly of mold units;
(4) inserting and securing a flat plastic or wooden stick into the slot opening of the central collar of each lid member if the lid provides said slot opening, and dividing said stick into a handle and an anchor;
(5) placing liquid confection material into the receptacles of the mold units;
(6) snuggly fitting the lids over the openings of the receptacles;
(7) placing the assembly of filled mold units into a freezer and waiting until the liquid confection material is frozen;
(8) removing the assembly of mold units containing the frozen confections from the freezer, untying the releasable and reclosable strap and taking and setting aside the desired number of mold units containing the frozen confections for immediate consumption;
(9) closely packing the unused mold units containing frozen confections into a new and smaller bundle and tying said bundle together using the releasable and reclosable strap, and returning the smaller mold assembly to the freezer compartment; and
(10) heating the frozen confections in the set-aside molds using a microwave oven to quickly and conveniently thaw the outer layer of the frozen confections to release said frozen confections from the molds.

The heating time needed to heat the mold units in the microwave oven to release and remove the frozen confections varies depending on the power of the microwave oven and on the number of frozen confections that are in the molds depends on the power of the microwave oven and the size of the frozen bars. Normally the required heating time for each individual mold unit is in the range of from at least about 2 seconds, at least about 4 seconds, at least about 5 seconds and up to about 20 seconds, up to about 15 seconds, up to about 10 seconds. Heating several mold units at the same time requires the multiple or slightly less of the individual heating times. When using the article of manufacture of the present invention for the first time, a consumer may need to determine the heating time that is appropriate with his or her particular microwave oven.

Some embodiments of the invention will now be described by way of example hereinafter with reference to the drawings. Similar reference numbers denote corresponding features throughout the drawings. The elements of one embodiment can be combined with those of other elements, or can be used alone.

Those skills in the art will recognize that other forms of this general type of molds can be used without departing from the scope of the present invention.

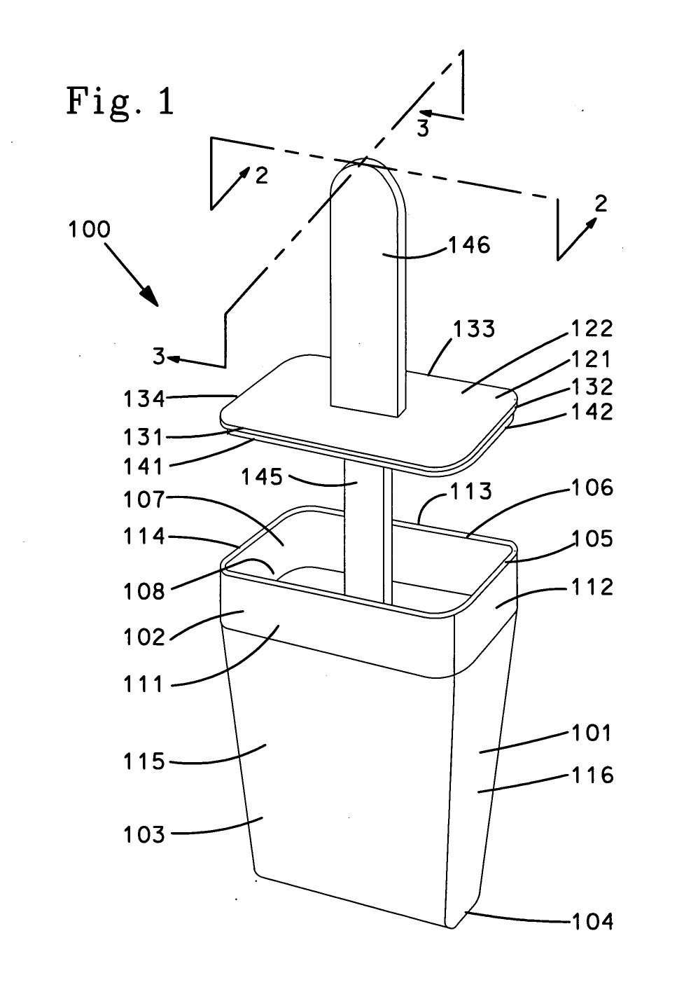

FIG. 1 is an exploded perspective view of an embodiment of a modular mold unit of the present invention, said modular mold unit 100 comprises the container member 101 and a removable lid member 121. The container member 101 is a receptacle comprising a rounded rectangular flange section 102 with rounded vertical edges joining with a lower tapered rectangular prism section 103 with rounded edges, a rectangular bottom side 104, and a rectangular top side 105 comprising rim 106 and opening 107 of cavity 108 that receives and holds the flavored liquid syrup to be frozen. The rectangular flange section 102 comprises two long vertical sides 111 and 113, and two short vertical sides 112 and 114 and the lower tapered prism section 103 comprises four tapering sides 115, 116, 117 (hidden), and 118 (hidden). The upper vertical sides 111, 112, 113, and 114 superiorly share the same edges with the rectangular top side 105 and inferiorly share the same edges with the tapering sides 115, 116, 117, and 118, respectively, and the lower edges of the tapering sides 115, 116, 117, and 118 share the same edges with the rectangular bottom side 104. The detachable rectangular lid member 121 comprises the lid body 122 with edges 131, 132, 133, and 134 that fit with the outside edges of rim 106 of the container 101 at vertical top sides 111, 112, 113, and 114, respectively. At its bottom side, lid member 121 has raised ridges 141, 142, 143 (hidden), and 144 (hidden) that fit snuggly to the inside edges of rim 106 of container 101. Integrally molded to lid 121 are an interior elongated stick member (or anchor) 145 and an exterior elongated member (or handle) 146. The interior anchor 145 which can be flat (as shown) or have indentations or transverse ridges (not shown) must be sufficiently long to enable the frozen confection to be formed thereon and also have sufficient strength to hold a frozen confection while it is being consumed. The exterior handle 146, which can be flat (as shown) or other configurations (such as having indentations or transverse ridges, not shown) enables the consumer to grip and hold the lid member 121 with the frozen confection thereon while the frozen confection is being consumed. Preferably the modular mold unit is made using plasticizer-free, unadulterated, nonrecycled, heat-stable, microwave-transmissible plastic to allow convenient heating in a microwave oven for a quick release of the frozen confections from the mold.

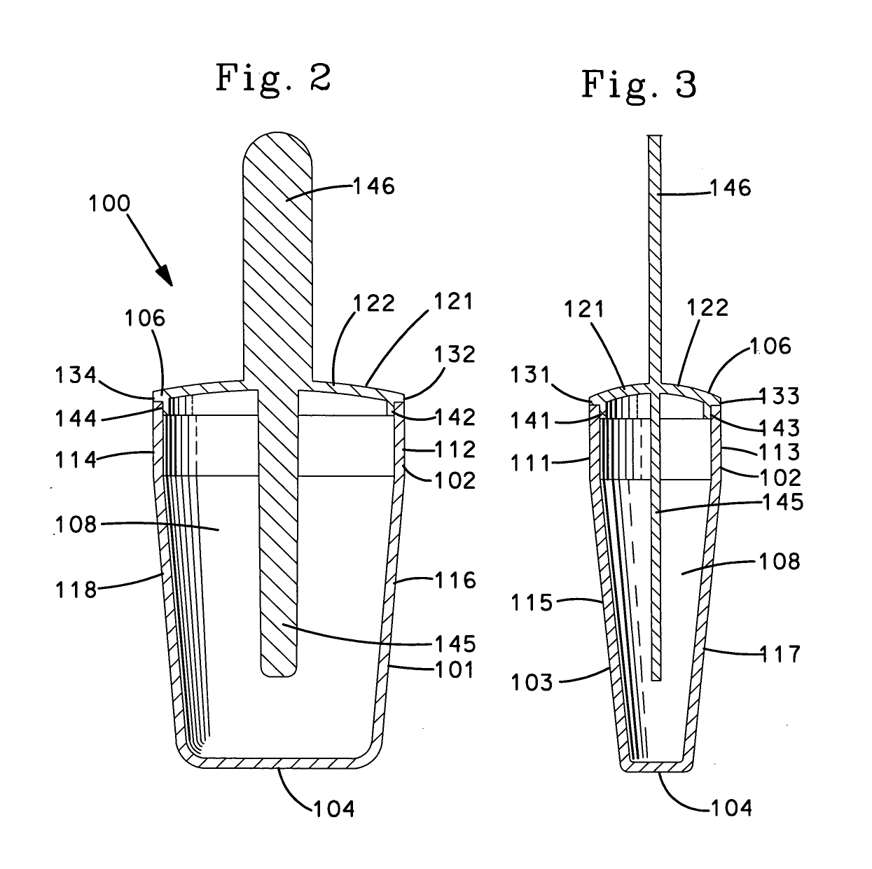

FIG. 2 is a cross-sectional view of the modular mold unit of FIG. 1 showing the broad view of the container member 101 with the detachable lid member 121 fitted to the container member, taken along line 2-2 of FIG. 1.

FIG. 3 is a cross-sectional view of the modular mold unit of FIG. 1 showing the side view of the container member 101 with the detachable lid member 121 fitted to the container member, taken along line 3-3 of FIG. 1.

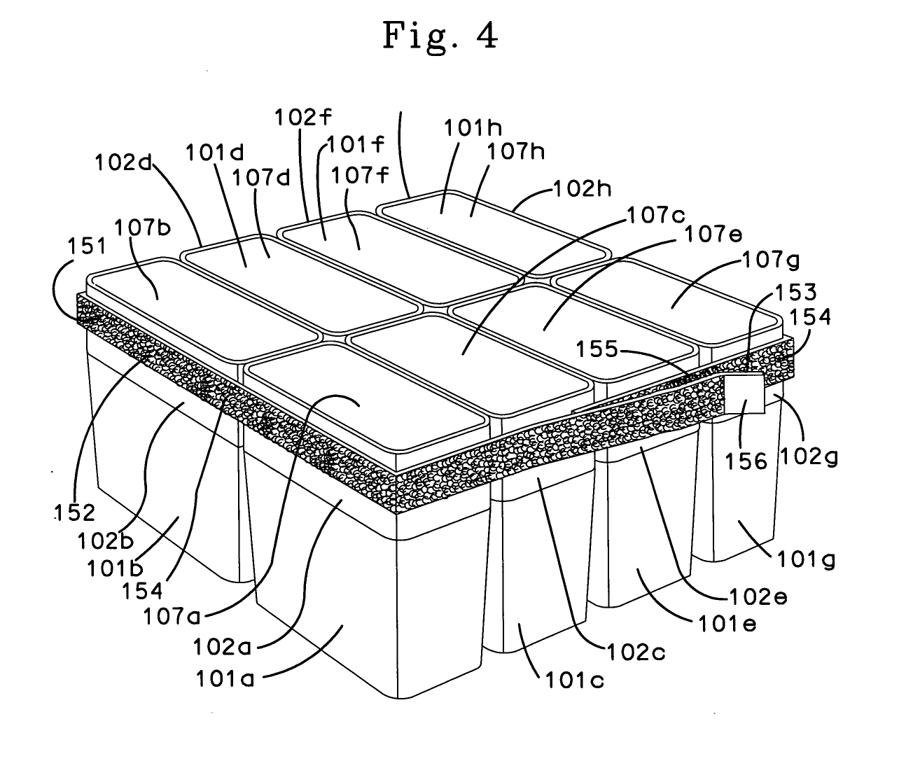

FIG. 4 is a perspective view of an assembly of a plurality of the container members of the modular mold unit of FIG. 1 of the present invention wherein the container members (eight containers in this case, from 101a through 101h) are closely stacked to one another and firmly held together by a Velcro®-type strap 151 at the level of the vertical rectangular flange sections 102 (from 102a through 102h). The loop and hook mating Velcro-type strap usually has one side fully covered with loops and the mating side fully covered with hooks. FIG. 4 shows the preferred strap 151 wherein side 152 is fully covered with loops 154 while side 153 is covered with hooks 155 only at one end and with tip 156 not covered to facilitate the opening of the strap to release the modular mold units. When the desired number of mold units containing frozen confections has been taken, the remainder of mold units can be re-tied together using the Velcro strap and stored again in the freezer compartment without taking extra room in the freezer.

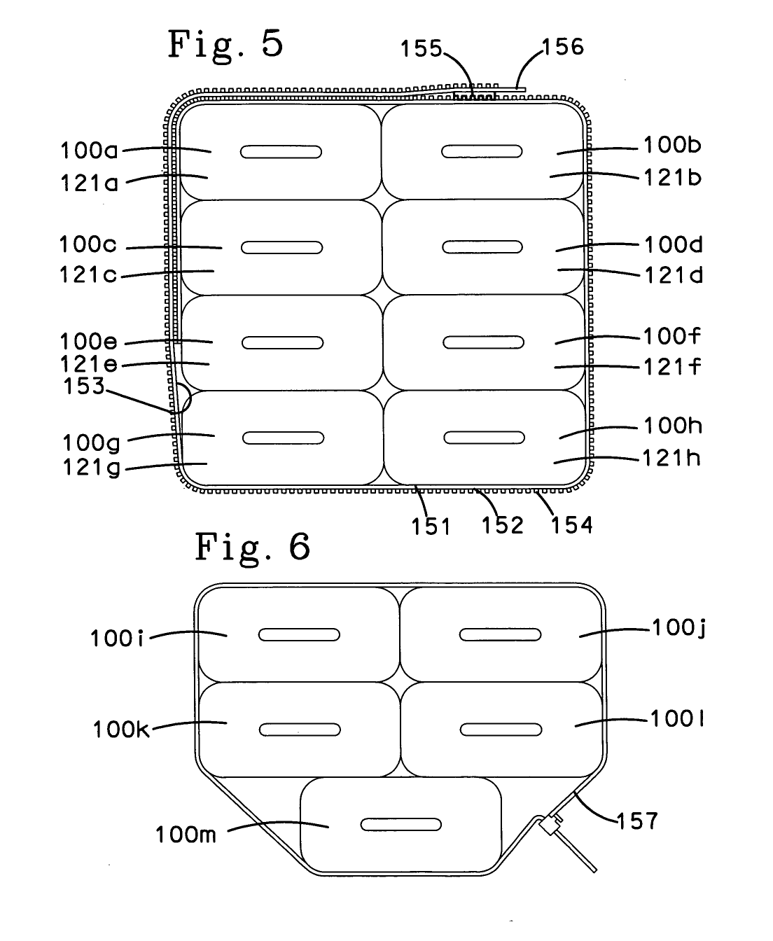

FIG. 5 is an overhead view of an assembly of a plurality of modular mold units of FIG. 1 of the present invention (eight units in this case), showing the eight mold unit 100 (from 100a through 100h) and the eight lid members 121 (from 121a through 121h), and wherein the container members (hidden by the lid members) are firmly held together by the preferred Velcro®-type strap 151 of FIG. 4.

FIG. 6 is an overhead view of another assembly of a plurality of modular mold units of FIG. 1 of the present invention wherein the mold units (five units in this case, from 100i through 100m) are firmly held together by a reclosable cable-tie-type strap 157. Tie 157 can be opened to release the modular mold units containing frozen confections. When the desired number of mold units containing frozen confections has been taken, the remainder of mold units can be re-tied together using the reclosable cable-tie-type strap 157 and stored again in the freezer compartment without taking extra room in the freezer.

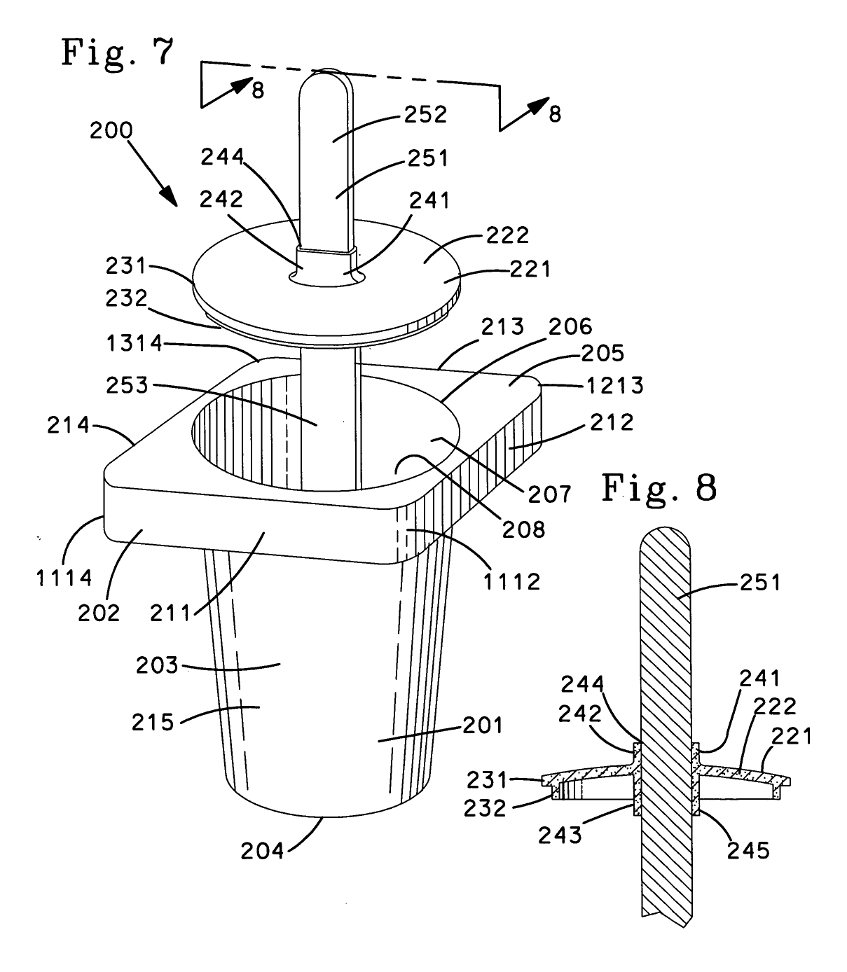

FIG. 7 is an exploded perspective view of another embodiment of a modular mold unit of the present invention, said modular unit 200 comprises the container member 201 and a removable lid member 221. The container member 201 is a receptacle comprising a rounded vertical square flange section 202, an inner tapered circular cylindrical container section 203, and a square top side 205. The square flange section 202 comprises four equal vertical sides 211, 212, 213, and 214, and a square top side 205 comprising the circular rim 206 and opening 207 of cavity 208 that receives and holds the liquid syrup to be frozen. The upper vertical sides 211, 212, 213, and 214 superiorly join with the outer edges with the square top side 205. Vertical sides 211 and 212 join at round edge 1112; vertical sides 211 and 214 join at round edge 1114; vertical sides 212 and 213 join at round edge 1213; and vertical sides 213 and 214 join at round edge 1314. The cavity 208 is formed by the tapered circular cylindrical container section 203, wherein said container section has the tapered circular cylindrical side 215, with the upper circular edge joining with the circular rim 206 of the top side 205 and the lower circular edge joining with the circular bottom side 204. The detachable lid member 221 comprises the lid body 222 with circular edge 231 that fits over the outside edges of circular rim 206 of the top side 205 of container 201. At its bottom side, lid member 221 has the raised circular ridges 232 (interior to edge 231) that fits snuggly to the inside edges of rim 206 of container 201. Situated centrally on lid 221 is a central collar 241 comprising an exterior portion 242 with opening 244 and interior portion 243 (not shown) with opening 245 (not shown), wherein opening 244 and opening 245 are parts of the longitudinal slot 246 which frictionally holds a separate elongated flat stick 251 with rounded ends that comprises an exterior portion 252 serving as the handle and an interior portion 253 serving as the anchor to hold a frozen confection. Stick 241 can be made of wood or molded microwave safe plastic. Lid 221 is preferably made of microwave safe plastic, preferably of semi-rigid silicone rubber, that allows it to fit closely to the rim 206 of opening 208 of container 201. A preferred lid 231 made of semi-rigid silicone rubber can also better enable the slot opening 246 of central collar 241 to grip the inserted stick 251 and allows a snuggly fitting of stick 251 into the slot opening 246.

FIG. 8 is the cross-sectional view of the removable lid member 221 of FIG. 7 showing the broad side view of the lid, taken along line 8-8 of FIG. 7 wherein the lid body 222 comprises edge 231, ridge 232, and central collar 241 comprising the exterior portion 242 with slot opening 244 and interior portion 243 with slot opening 245, showing the broad side of slot opening 246 that holds the broad side of stick 251.

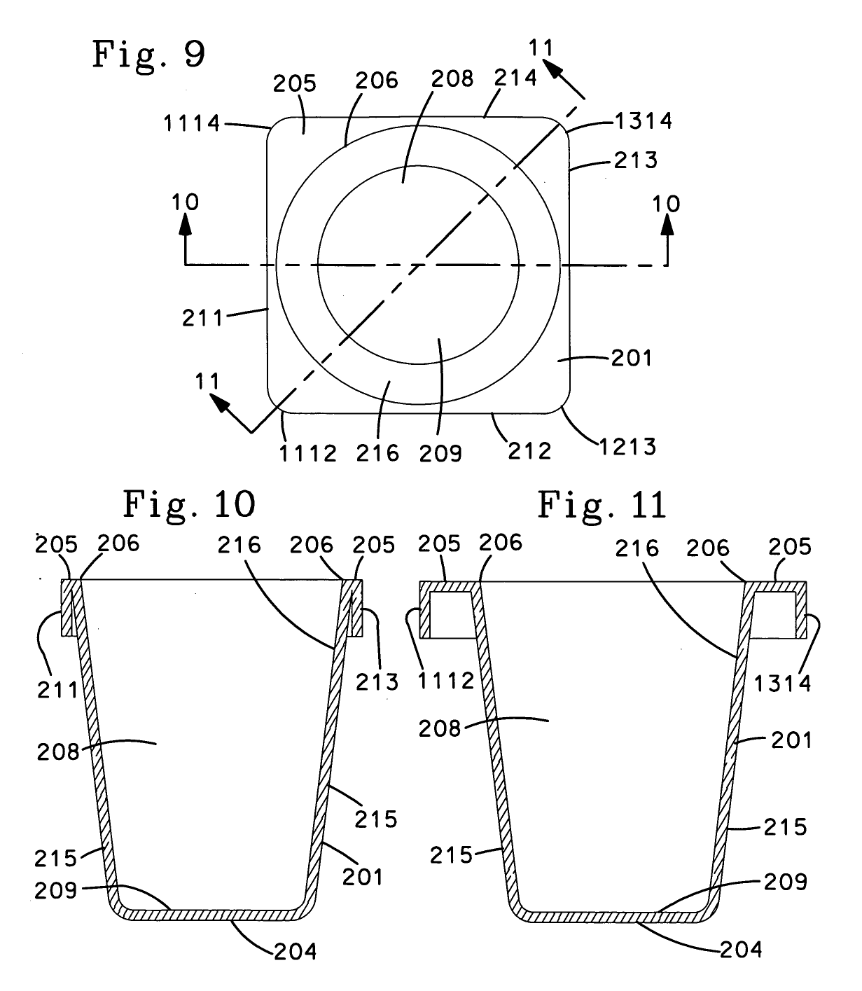

FIG. 9 is an overhead view of the container member 201 of the modular mold unit of FIG. 7 showing the square top side 205 comprising the outer sides 211, 212, 213, and 214, and the circular rim 206 of the container section 203. The cavity 208 reveals the inner side 209 of the circular bottom side 204, and the inner side 216 of the tapered circular cylindrical side 215.

FIG. 10 is the cross-sectional view of the container member 201 of FIG. 9 showing the side view of said container member 201 taken along line 10-10 of FIG. 9.

FIG. 11 the a cross-sectional view of the container member 201 of FIG. 9 showing the diagonally oblique side view of said container member 201 taken along line 11-11 of FIG. 9.

The above description discloses, by way of example, some typical embodiments of the present invention. However, persons of ordinary skill in the art are capable of creating numerous modifications within the scope of the claims. Changes in specifics of form and details can be made to the above-described embodiments. The claims and not the examples are the measure of the protected invention.

What is claimed is:

1. A modular mold unit for making frozen confection comprising a container member and a removable lid member; wherein said container member comprises a top side having an opening to a receptacle to receive and hold a flavored liquid syrup to be frozen, and a body side that comprises a vertical rectangular or square flange section with four vertical sides; wherein said removable lid member comprises a raised ridge that fits snuggly over said opening to the receptacle, an interior stick-like anchor to support the frozen confection and an exterior handle, wherein said interior stick-like anchor and said exterior handle are integrally molded to said lid; and wherein said container member and said lid member are made of plasticizer-free, unadulterated, nonrecycled, heat-stable, microwave-transmissible plastic.

2. The modular mold unit of claim 1, wherein said top side is rectangular, said vertical flange section forms an upper rectangular tube comprising two opposing vertical sides with long width and two opposing vertical sides with short width, wherein said receptacle comprises a tapered rectangular prism section, and wherein said vertical sides superiorly share the same edges with said rectangular top side, and inferiorly share the same edges with said tapered rectangular prism section.

3. The modular mold unit of claim 2, wherein said rectangular top side has rounded corners, said rectangular flange section has vertical rounded edges, and said tapered rectangular prism section has rounded edges.

4. The modular mold unit of claim 3, wherein said removable lid member is a stick-supporting lid having a central collar with a longitudinal slot that is centrally located in said lid to frictionally hold and support a separate wooden or plastic stick and to divide said stick into a handle and an anchor, wherein said stick replaces the integrally molded stick and handle, and wherein said lid member is optionally made of semi-rigid silicone rubber.

5. The modular mold unit of claim 1, wherein said top side is square, said vertical flange section forms an upper square tube comprising four equal vertical sides, wherein said receptacle comprises a tapered circular cylindrical section, and wherein said vertical sides superiorly share the same edges with said square top side.

6. The modular mold unit of claim 5, wherein said square top side has rounded corners and said square tube section has vertical rounded edges.

7. The modular mold unit of claim 6, wherein said removable lid member is a stick-supporting lid having a central collar with a longitudinal slot that is centrally located in said lid to frictionally hold and support a separate wooden or plastic stick and to divide said stick into a handle and an anchor, wherein said stick replaces the integrally molded stick and handle, and wherein said lid member is optionally made of semi-rigid silicone rubber.

8. The modular mold unit of claim 1 wherein the plasticizer-free, unadulterated, nonrecycled, microwave-transmissible plastic is selected from the group consisting of high density polyethylene, low density polyethylene, polypropylene, polyethylene terephthalate, and semi-rigid silicone rubber.

9. A mold assembly comprising a plurality of modular mold units of claim 1, further including a reclosable and releasable strap that releasably holds said mold units to one another.

10. The mold assembly of claim 9, wherein said container member comprises a rectangular top side having an opening to a receptacle and a body side comprising a vertical rectangular flange section with four vertical sides, wherein said receptacle comprises a tapered rectangular prism section, wherein said rectangular top side has rounded corners, said rectangular flange section has vertical rounded edges, and said tapered rectangular prism section has rounded edges, wherein said removable lid member comprises either an interior stick-like anchor and an exterior handle which are integrally molded to said lid; or a central collar with a longitudinal slot that is centrally located in said lid to frictionally hold and support a separate wooden or plastic stick and to divide said stick into a handle and an anchor, and wherein said strap is selected from the group consisting of Velcro strap, reclosable cable tie, and rubber band.

11. The mold assembly of claim 10, wherein said container member comprises a square top side having an opening to a receptacle and a body side comprising a vertical flange section forms an upper square tube comprising four equal vertical sides, wherein said receptacle comprises a tapered circular cylindrical section, and wherein said square top side has rounded corners and said square tube section has vertical rounded edges.

12. An article of manufacture comprising a plurality of modular mold units, one or more of the reclosable and releasable straps, optionally a plurality of wooden or plastic sticks, and instructions for use, wherein each said mold unit comprises a container member and a removable lid member; wherein said container member comprises a rectangular top side having an opening to a receptacle, and a body side comprising a vertical rectangular flange section with four vertical sides; wherein said removable lid member comprises either an interior stick-like anchor and an exterior handle which are integrally molded to said lid; or a central collar with a longitudinal slot that is centrally located in said lid to frictionally hold and support a separate wooden or plastic stick and to divide said stick into a handle and an anchor, and wherein said container member, said lid member, and said separate plastic stick are made of plasticizer-free, unadulterated, nonrecycled, heat-stable, microwave-transmissible plastic.

13. The article of claim 12 wherein said removable lid comprising a central collar with a longitudinal slot is made of semi-rigid silicone rubber.

14. The article of claim 12 wherein said instructions for use indicate that: the molds can be used to save space in the freezer compartment; the molds can be safely used in a microwave oven for quickly, conveniently, and hygienically releasing the confections from the molds; and the way to determine the length of time to heat in a microwave oven; wherein said instructions for use are printed on one or more of: the package; the accompanying instruction flyer; and/or communicated via print and/or electronic mass media: newspapers, magazines, radio, television, internet, circulars, and the like, and wherein said instructions can be in words, or illustrative images and/or icons including in combination with words.

15. The article of claim 12 wherein said container member comprises a square top side having an opening to a receptacle and a body side comprising a vertical flange section forms an upper square tube comprising four equal vertical sides, and wherein said receptacle comprises a tapered circular cylindrical section.

16. The article of claim 15 wherein said removable lid comprising a central collar with a longitudinal slot is made of semi-rigid silicone rubber.

17. A method for production of frozen confections that allows the preparation of an exact number of frozen confections on a stick that are needed without causing extra dead space in the freezer compartment of a home refrigerator, and that allows a quick and convenient release of the frozen confections by a microwave oven, said method including the steps of:
(1) providing a plurality of modular mold units, wherein each said mold unit comprises a container member and a removable lid member; wherein said container member comprises a rectangular top side having an opening to a receptacle, and a body side comprising a vertical rectangular flange section with four vertical sides; wherein said removable lid member comprises either an interior stick-like anchor and an exterior handle which are integrally molded to said lid; or a central collar with a longitudinal slot that is centrally located in said lid to frictionally hold and support a separate wooden or plastic stick and to divide said stick into a handle and an anchor, and wherein said container member, said lid member, and said separate plastic stick are made of plasticizer-free, unadulterated, nonrecycled, heat-stable, microwave-transmissible plastic.
(2) closely stacking the desired number of modular mold units together with one or more of the vertical sides of one mold unit being placed flatly against one or more of the vertical sides of other mold units to form a mold assembly comprising a bundle of mold units;
(3) firmly holding and tying said bundle together using the releasable and reclosable strap to form an assembly of mold units;
(4) inserting and securing a flat plastic or wooden stick into the slot opening of the central collar of each lid member if the lid provides said slot opening, and dividing said stick into a handle and an anchor;
(5) placing liquid confection material into the receptacles of the mold units;
(6) snuggly fitting the lids over the openings of the receptacles;
(7) placing the assembly of filled mold units into a freezer and waiting until the liquid confection material is frozen;
(8) removing the assembly of mold units containing the frozen confections from the freezer, untying the releasable and reclosable strap and taking and setting aside the desired number of mold units containing the frozen confections for immediate consumption;
(9) closely packing the unused mold units containing frozen confections into a new and smaller bundle and tying said bundle together using the releasable and reclosable strap, and returning the smaller mold assembly to the freezer compartment and
(10) heating the frozen confections in the set-aside molds using a microwave oven to quickly and conveniently release the frozen confections from the molds.

18. The method of claim 17 wherein said removable lid comprising a central collar with a longitudinal slot is made of semi-rigid silicone rubber.

19. The method of claim 17 wherein said container member comprises a square top side having an opening to a receptacle, and a body side comprising a vertical square flange section forming an upper square tube comprising four equal vertical sides.

20. The method of claim 19 wherein said removable lid comprising a central collar with a longitudinal slot is made of semi-rigid silicone rubber.
